(19) United States
(12) Patent Application Publication
(10) Pub. No.: US 2008/0232833 A1
(43) Pub. Date: Sep. 25, 2008

(54) IMAGE FORMING APPARATUS AND IMAGE FORMING METHOD

(76) Inventor: Yuichiro Shukuya, Tokyo (JP)

Correspondence Address: DICKSTEIN SHAPIRO LLP, 1825 EYE STREET NW, Washington, DC, 20006-5403, US

(21) Appl. No.: 12/048,841

(22) Filed: Mar. 14, 2008

(30) Foreign Application Priority Data
Mar. 19, 2007 (JP) 2007-069833

(51) Int. Cl. G03G 15/00

(52) U.S. Cl. 399/38

(57) ABSTRACT

An image forming apparatus is disclosed that has an optical device including an optical source that is driven corresponding to image data, a deflection unit that deflects an optical beam output from the optical source in a main scanning direction, and an optical element that reflects the optical beam onto a photosensitive drum; a detection device that is arranged outside the optical device and detects a positional shift of the optical beam in a sub-scanning direction defined as a direction orthogonal to the main scanning direction; and a control unit that corrects the positional shift in the sub-scanning direction using an output from the detection device.

### BACKGROUND OF THE INVENTION

1. Field of the Invention

The present invention relates generally to image forming apparatuses and, in particular, to an image forming apparatus and an image forming method that correct out of sync conditions in a sub-scanning direction.

2. Description of the Related Art

Image forming apparatuses using an optical device are configured to scan a photosensitive body in such a way that an optical beam generated by a semiconductor laser, a laser diode, etc., is modulated with image data and deflected in a main scanning direction with a deflection unit (hereinafter referred to as a polygon mirror) to pass through an fθ lens.

In typical color image forming apparatuses, the shape and the refractive index of a plastic lens are changed due to variations in the optical device and the characteristics of the plastic lens as well as changes in an environmental temperature and an in-machine temperature. As a result, the image forming position and the size of each color latent image are caused to be shifted, thereby making it impossible to provide clear images.

In order to deal with this problem, Patent Documents 1 and 2 pay particular attention to a color shift in a sub-scanning direction and disclose methods of correcting the amount of the color shift. Specifically, Patent Document 1 discloses a method in which an optical beam is used and the color shift in the sub-scanning direction is corrected using a detection device that detects a scanning position in the sub-scanning direction. Furthermore, Patent Document 2 proposes a method in which a color shift detection pattern is drawn on an intermediate transfer belt and read by a color shift detection sensor to calculate and correct the amount of the color shift.

According to the configurations disclosed by Patent Documents 1 and 2, the detection device is arranged in an optical device having an optical source such as a semiconductor laser and a polygon mirror. Thus, it is possible to correct the amount of the color shift in the sub-scanning direction, which is caused by the change in the positions of lenses and mirrors in the optical device.

Patent Document 1: JP-A-2005-37575

Patent Document 2: JP-A-2004-333994

### SUMMARY OF THE INVENTION

Meanwhile, the color shift in the sub-scanning direction on a photosensitive body is susceptible also to variations in the mounting positions of the optical device and a photosensitive body unit. Therefore, the methods of Patent Documents 1 and 2 cannot correct the color shift in the sub-scanning direction due to factors other than one caused by the optical device.

Moreover, in order to correct for positional shifts, it is necessary to perform a correction process in which a reference pattern is created every time images are formed, resulting in wasting the correction process a number of times, correction time, and consumable items.

The present invention has been made in view of the above problems and directed to arrange a detection device that detects a scanning position in the sub-scanning direction outside an optical device, and more specifically, in the vicinity of a position where a photosensitive drum is irradiated with an optical beam, thereby making it possible to correct with high accuracy a shift amount attributable to a main body structure section and the photosensitive drum in addition to a shift amount inside the optical device in the vicinity of an image forming position of the photosensitive drum.

According to the embodiments of the present invention, the detection device that detects a positional shift in the sub-scanning direction is provided in the vicinity of or at a position adjacent to the photosensitive drum inside the image forming apparatus.

The detection device is composed of a control unit (CPU) and an irradiation position detection unit including an irradiation sensor and an irradiation position sensor. The detection device detects the irradiation of an optical beam with the irradiation position sensor, and it detects a position where the irradiation position sensor is irradiated with the optical beam. The control unit stores the value of a normal position, where an optical beam does not cause a positional shift in the sub-scanning direction, in nonvolatile memories such as an EEPROM, an EPROM, and a flash memory and uses the value as the reference value of a set position. The value of the set position is read into a register memory or the like of the control unit as the reference value when the image forming apparatus performs the operation, and it is used to control the position in the sub-scanning direction.

The irradiation position sensor generates a detection signal based on the irradiation position of an optical beam. Where a positional shift in the sub-scanning direction occurs, the control unit calculates a shift amount in the sub-scanning direction using the irradiation signal from the irradiation sensor and the detection signal from the irradiation position sensor. If it is determined that the shift amount in the sub-scanning direction exceeds a threshold ε, the control unit generates a control signal to control the drive timing of the optical source of an optical beam in units of lines in the sub-scanning direction, the peripheral speed of the photosensitive drums, and the translation position and the rotational angle of the reflection mirrors, thereby correcting the positional shift in the sub-scanning direction.

According to the embodiments of the present invention, it is not necessary to draw a color shift detection pattern, thereby making it possible to shorten correction time and reduce wasteful toner consumption. Moreover, since the correction time can be shortened, it is possible to increase the frequency of corrections. Accordingly, the color matching accuracy, color reproducibility, and picture stability can be improved with time.

According to one aspect of the present invention, there is provided an image forming apparatus. The apparatus comprises an optical device including an optical source that is driven corresponding to image data, a deflection unit that deflects an optical beam output from the optical source in a main scanning direction, and an optical element that reflects the optical beam onto a photosensitive drum; a detection device that is arranged outside the optical device and detects a positional shift of the optical beam in a sub-scanning direction defined as a direction orthogonal to the main scanning direction; and a control unit that corrects the positional shift in the sub-scanning direction using an output from the detection device.

It is preferable the detection device include an irradiation sensor and an irradiation position sensor, and the irradiation position sensor be disposed in such a way as to be flush with the photosensitive drum of the image forming apparatus relative to the optical beam. Furthermore, the control unit can correct the positional shift in the sub-scanning direction by controlling the drive timing of the optical beam in units of lines in the sub-scanning direction, the transfer timing of a developing agent image of the photosensitive drum onto an intermediate transfer belt, or a spatial position of the optical element. Furthermore, the control unit can detect inter-sheet timing of the image forming apparatus to correct the positional shift. Furthermore, the irradiation position sensor can be obliquely arranged relative to the irradiation sensor.

According to another aspect of the present invention, there is provided an image forming method of an image forming apparatus having an optical device including an optical source that is driven corresponding to image data, a deflection unit that deflects an optical beam output from the optical source in a main scanning direction, and an optical element that reflects the optical beam to a photosensitive drum. The method comprises a detection step of detecting the optical beam in a sub-scanning direction defined as a direction orthogonal to the main scanning direction outside the optical device and at a surface level of the photosensitive drum of the image forming apparatus; a calculation step of calculating a shift amount in the sub-scanning direction based on a positional shift of the detected optical beam; a control step of controlling the calculated shift amount to be corrected; and an output step of outputting an image in which the positional shift in the sub-scanning direction is corrected.

The calculation step can include a step of calculating a difference between the optical beam having a different scanning period and a set position in the sub-scanning direction. The control step can include a step of calculating, using the shift amount between the optical beam and the set position, a difference in timing of the optical beam in units of lines in the sub-scanning direction, a difference in a peripheral speed of the photosensitive drum, a difference in a translational position of the optical element, or a difference in a rotational angle of the optical element.

The control step can further include a step of detecting inter-sheet timing of the image forming apparatus; and a step of calculating the shift amount within the inter-sheet timing, starting a correction of the shift amount if the shift amount exceeds a threshold, and completing the correction within the inter-sheet timing.

The control step can further include a step of detecting inter-sheet timing of the image forming apparatus; a step of determining whether the shift amount exceeds a threshold after starting a correction of the shift amount at the inter-sheet timing; and a step of starting the correction if it is determined that the shift amount exceeds the threshold and completing the correction within the inter-sheet timing.

Other objects, features and advantages of the present invention will become more apparent from the following detailed description when read in conjunction with the accompanying drawings.

### BRIEF DESCRIPTION OF THE DRAWINGS

FIG. 1 shows an embodiment of an image forming apparatus;

FIG. 2 is a plan view of the image forming apparatus viewed from the direction as indicated by arrow A in FIG. 1;

FIG. 3 shows a detailed configuration of a detection device viewed from the direction as indicated by arrow D in FIG. 2;

FIG. 4 shows a timing chart for detecting a shift amount in a sub-scanning direction (length dimension) directly using a time signal;

FIG. 5 shows another embodiment of the detection device;

FIG. 6 shows a second embodiment of a detection circuit including a CPU and a control method;

FIG. 7 shows a third embodiment of control performed by the CPU;

FIG. 8 shows another embodiment of the detection device that can be used with the control method as described in FIG. 7;

FIG. 9 shows a timing chart of a process for detecting a shift amount in the sub-scanning direction performed by the image forming apparatus;

FIGS. 10A and 10B show second and third embodiments of correction control, respectively;

FIG. 11 shows a flowchart of a first embodiment of the image forming method performed by the image forming apparatus; and

FIG. 12 shows a flowchart of a second embodiment of the image forming method performed by the image forming apparatus.

### DETAILED DESCRIPTION OF THE PREFERRED EMBODIMENTS

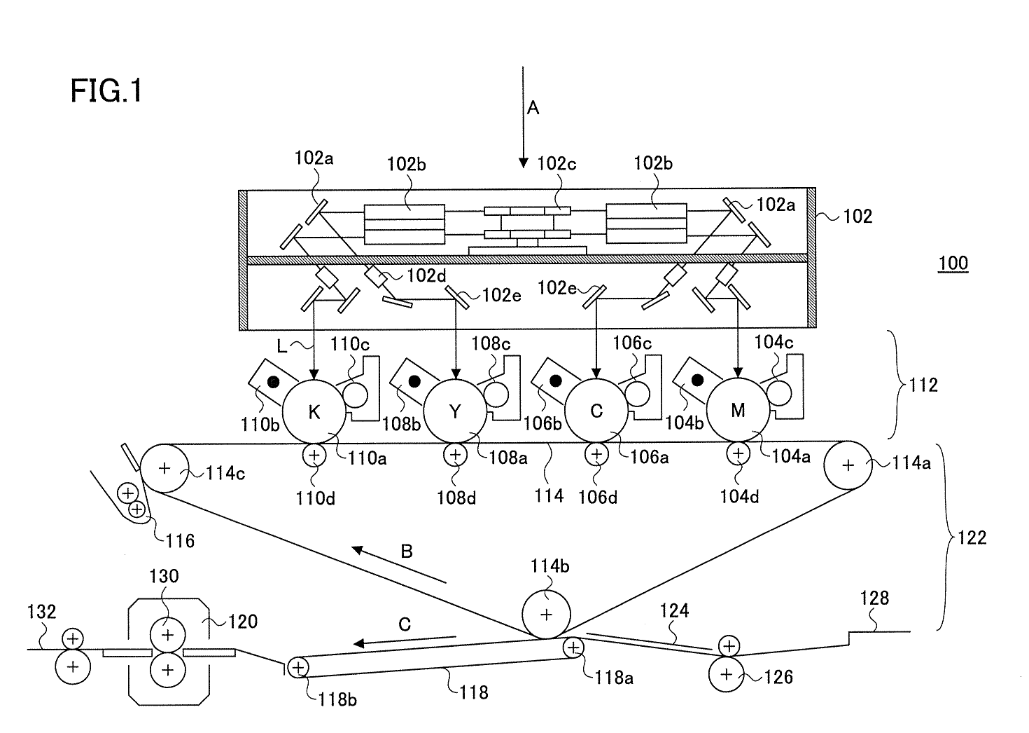

Next, a description is made of the present invention based on embodiments, but the present invention is not limited to the embodiments below. FIG. 1 shows the embodiment of an image forming apparatus. The image forming apparatus 100 is composed of an optical device 100 including optical elements such as a semiconductor laser and a polygon mirror, an image forming section 112 including photosensitive drums, chargers, developing units, etc., and a transfer section 122 including an intermediate transfer belt, etc. In the optical device 102, an optical beam from an optical source such as a semiconductor laser (not shown) is deflected with a polygon mirror 102c and then incident on an fθ lens. In the embodiment shown in FIG. 1, the optical beam is generated by an amount corresponding to each color of cyan (C), magenta (M), yellow (Y), and black (K), and it is reflected with reflection mirrors 102a after passing through the fθ lens 102b.

After forming the optical beam, WTL lenses 102d deflect it to reflection mirrors 102e. Then, the optical beam is applied onto the photosensitive drums 104a, 106a, 108a, and 110a as an optical beam L used for exposure of latent images. Since the irradiation of the optical beam L onto the photosensitive drums 104a, 106a, 108a, and 110a is performed using plural of the optical elements described above, timing synchronization is performed with respect to a main scanning direction and a sub-scanning direction. Note that in the following description the main scanning direction is defined as the scanning direction of an optical beam, and the sub-scanning direction is defined as the direction orthogonal to the main scanning direction, i.e., the rotational direction of the photosensitive drums 104a, 106a, 108a, and 110a in the typical image forming apparatus 100.

The photosensitive drums 104a, 106a, 108a, and 110a each have a photoconductive layer including at least a charge generation layer and a charge transfer layer on a photoconductive drum made of aluminum or the like. The photoconductive layer is disposed on the respective photosensitive drums 104a, 106a, 108a, and 110a, and surface charge is applied to the photoconductive layers with the chargers 104b, 106b, 108b, and 110b each composed of a corotron, a scorotron, a charging roller, etc.

The electrostatic charges applied onto the photosensitive drums 104a, 106a, 108a, and 111a with the chargers 104b, 106b, 108b, and 110b are exposed with the optical beam L to form electrostatic latent images. The electrostatic latent images formed onto the photosensitive drums 104a, 106a, 108a, and 110a are developed with developing units 104c, 106c, 108c, and 110c each including a developing sleeve, a developing agent supply roller, a control blade, etc., to form developing agent images.

The developing agent images carried on the photosensitive drums 104a, 106a, 108a, and 110a are transferred onto an intermediate transfer belt 114, which moves in the direction as indicated by arrow B through conveyance rollers 114a, 114b, and 114c, through transfer rollers 104d, 106d, 108d, and 110d. The intermediate transfer belt 114 is conveyed to a secondary transfer section with the developing agent images of C, M, Y, and K carried thereon. The secondary transfer section is composed of a secondary transfer belt 118 and conveyance rollers 118a and 118b. The secondary transfer belt 118 is conveyed in the direction as indicated by arrow C through the conveyance rollers 118a and 118b. An image receiving member 124 such as a quality paper and a plastic sheet is supplied from an accommodation unit 128 such as a sheet feeding cassette accommodating an image receiving member to the secondary transfer section through conveyance rollers 126.

By applying a secondary bias, the secondary transfer section transfers the multicolor developing agent images carried on the intermediate transfer belt 114 onto the image receiving member 124 that is attracted and held on the secondary transfer belt 118. The image receiving member 124 is supplied to a fixation device 120 as the secondary transfer belt 118 is conveyed. The fixation device 120 is composed of fixation members 130 such as fixation rollers containing a silicon rubber, a fluorine-containing rubber, etc. The fixation device 120 pressurizes and heats the image receiving member 124 and the multicolor developing agent images and outputs the same to the outside of the image forming apparatus 100 as a printed material 132. The transfer belt 114, from which the multicolor developing agent images are transferred, is conveyed to a cleaning section 116 including a cleaning blade where the developing agent images left on the transfer belt 114 are removed, and then subjected to the subsequent image forming process.

Note that detection devices that detect a positional shift in the sub-scanning direction (not shown) are disposed in the vicinity of the terminal point in the main scanning direction of the respective photosensitive drums 104a, 106a, 108a, and 110a to detect the positional shift in the sub-scanning direction.

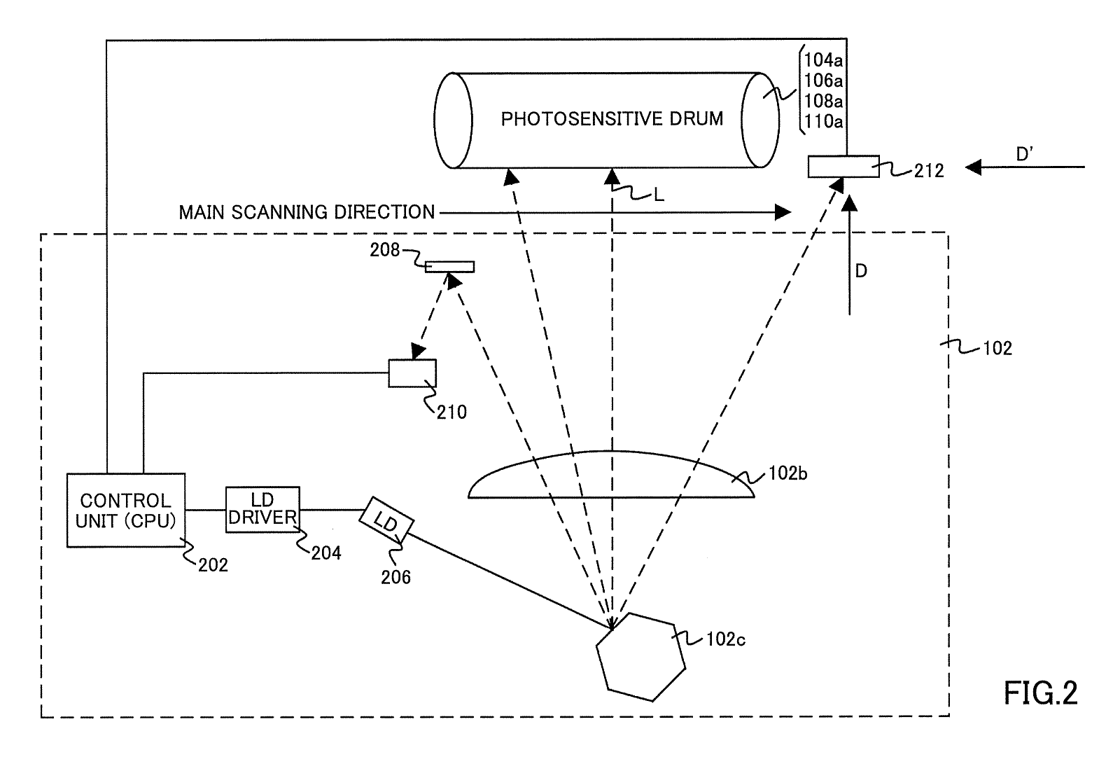

FIG. 2 is a plan view of the image forming apparatus 100 viewed from the direction as indicated by arrow A in FIG. 1. As shown in FIG. 2, the optical device 102 accommodates a control unit (CPU) 202, a LD driver 204 that drives a semiconductor laser, and a laser diode (LD) 206. In addition, the optical device 102 accommodates the polygon mirror 102c and the fθ lens 102b. The polygon mirror 102c is driven to rotate at a rotational speed of several thousands through several tens of thousands rpm and irradiates the polygon mirror 102c with the optical beam irradiated from the LD 206. The optical beam deflected with the polygon mirror 102c is incident on the fθ lens 102b and then irradiated as the optical beam L onto the photosensitive drums 104a, 106a, 108a, and 110a through the WLT lenses (not shown).

The LD driver 204 modulates the LD 206 corresponding to image data generated by converting the image data acquired by an image scanning section (not shown) into digital data and forms electrostatic latent images on the photosensitive drums. Note that the image scanning section is configured to be an ADF (Auto Document Feeder) or a scanner composed of a CCD (Charge Coupled Device) and the like. The optical beam from the LD 206 is deflected to a synchronization detection unit 210 with a reflection mirror 208 disposed at a position having no influence on image formation. The output from the synchronization detection unit 210 is input to the CPU 202 and used to take synchronization in the main scanning direction.

On the other hand, the detection devices 212 that detect a positional shift in the sub-scanning direction are disposed in the vicinity of or at a position adjacent to the photosensitive drums 104a, 106a, 108a, and 110a. The detection devices 212 are used to correct and control a positional shift in the sub-scanning direction by detecting the positional shift of the optical beam L in the sub-scanning direction, sending a detection signal to the CPU 202, and thereby controlling the irradiation timing of the LD 206, the peripheral speed of the photosensitive drum, or the translational or the rotational movement of the optical elements. The CPU 202 can be configured to be an ASIC and executes a program written in a programming language such as assembler to control the LD 206, modulate the LD 206 for image forming, and control the driving of the polygon mirror 102c. In addition, the CPU 202 executes the processing for detecting a positional shift in the sub-scanning direction and calculates a control value to correct the positional shift in the sub-scanning direction.

The calculated control value is supplied to a function section that performs a correction proccess, e.g., to the main control unit (not shown) of the image forming apparatus, thereby making it possible to provide instructions for correcting a positional shift in the sub-scanning direction. Furthermore, the CPU 202 can control the peripheral speed of the photosensitive drums by sending the calculated control value to a section that controls the driving of the photosensitive drums (not shown). Moreover, according to another embodiment of the present invention, the translational position or the rotational angle of the reflection mirrors 102e can be controlled by supplying the control value to a section (not shown) that controls the driving of the optical elements such as a pulse motor driver for activating the reflection mirrors 102e or the like.

The detection devices 212 can be disposed in the vicinity of the photosensitive drums 104a, 106a, 108a, and 110a. According to another embodiment of the present invention, the detection devices 212 can be mounted on the photosensitive drums 104a, 106a, 108a, and 110a. Even in any of the embodiments, the position for disposing the detection devices 212 is not particularly limited so long as a positional shift in the sub-scanning direction can be detected at a substantially surface level of the photosensitive drums.

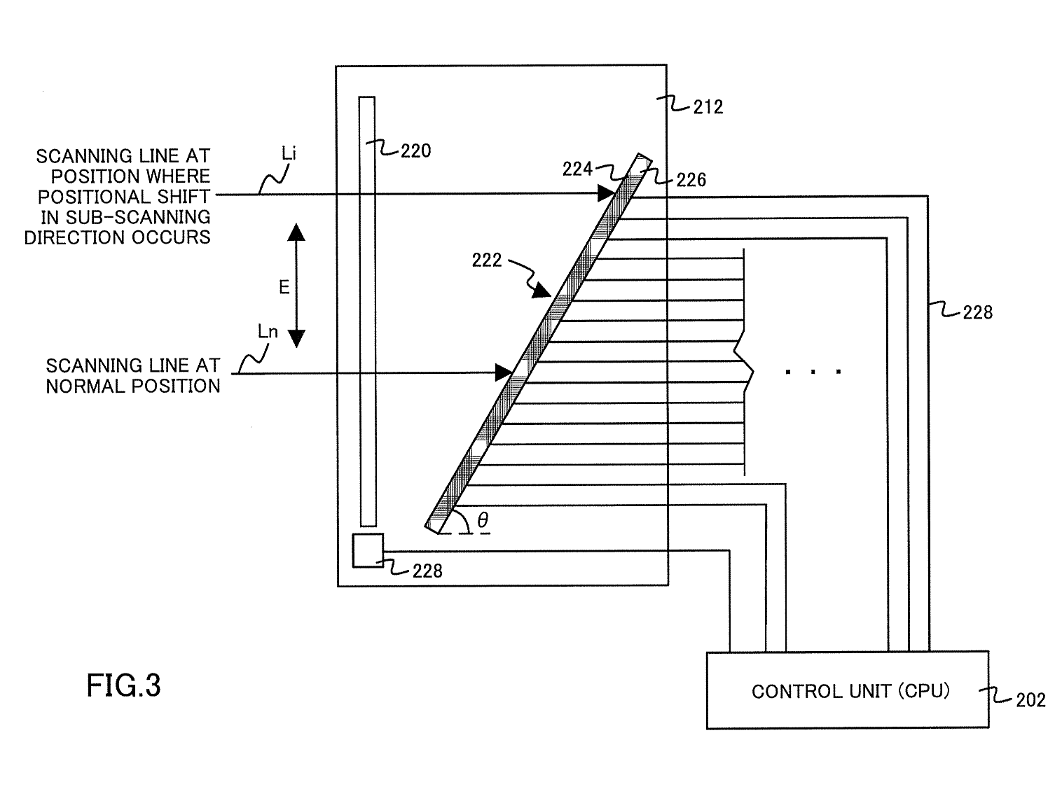

FIG. 3 shows a detailed configuration of the detection device 212 viewed from the direction as indicated by arrow D in FIG. 2. According to the embodiment shown in FIG. 3, the optical beam L incident on the detection device 212 is deflected with the polygon mirror 102c so as to come across a sheet in the direction orthogonal to the sub-scanning direction as indicated by arrow E along a main surface (in the direction along the sheet of FIG. 3) of the detection device 212. As shown in FIG. 3, the detection device 212 is composed of an irradiation sensor 220 and an irradiation position sensor 222. The irradiation sensor 220 is composed of a light transmitting material whose surface is coated with a light emitting material, a half mirror, or the like, and an optical beam Ln or an optical beam Li is irradiated from the irradiation sensor 220.

Note that, for the sake of convenience in explanation, FIG. 3 shows the optical beam Ln irradiated at a normal position and the optical beam Li irradiated at a position where a positional shift in the sub-scanning direction occurs. The optical beam Ln shows the locus of the optical beam L on the scanning line at the set position determined by a color shift detection pattern or the like or at the normal position free from a positional shift in the sub-scanning direction which is set smaller than or equal to a threshold ε relative to the set position. Furthermore, the optical beam Li shows an optical beam on the scanning line at an abnormal position where a positional shift in the sub-scanning direction exceeds the threshold ε. The detection device 212 is periodically irradiated with the optical beams Ln and Li at scanning intervals in the main scanning direction, and the CPU 202 periodically detects a shift amount.

The set position described above is a detection position for eliminating a color shift in such a way that the color shift is measured using a color shift detection pattern, etc., at the time of initial settings or regular maintenance. The value of the detection position is stored in an EEPROM or the like upon determination of the set position and read into the register memory of the CPU 202 upon activation of the image forming apparatus 100, and it is used as a reference value or a standard value for the subsequent control processing.

The irradiation sensor 220 generates fluorescence or phosphorescence with the irradiation of an optical beam and functions as a light guiding plate to supply an optical signal generated as fluorescence or phosphorescence to a photodiode (PIN) 228. The photodiode 228 receives the optical signal and generates an irradiation signal. The generated irradiation signal is input to the CPU 202 to supply a trigger pulse for starting a process of detecting a positional shift in the sub-scanning direction or a control pulse for generating a gate signal over a gate period.

In the exemplified embodiments, the irradiation position sensor 222 is composed of a cover plate 224 and an optical sensor 226 made of a photodiode array, a CCD, a CMOS sensor array, or the like. Note that, in the case of using the photodiode array, it is not necessary to particularly intentionally add the cover plate 224, and the protection plate of a photoelectric conversion element can be used as it is.

To this end, various light emitting materials can be used regardless of whether they are organic or inorganic. In order to efficiently absorb a semiconductor laser having a wavelength (of about 300 nm through 600 nm) and generate fluorescence or phosphorescence, phthalocyanine, metal oxide phthalocyanine such as titanyl phthalocyanine, metal phthalocyanine (copper phthalocyanine, iron phthalocyanine, etc.), or other sensitizing dyes can be coated, sputtered, or deposited. Furthermore, in order to obtain an accurate shift amount in the sub-scanning direction and a positional shift in an optical beam spot shape, the irradiation position sensor 222 on the side where an optical beam is irradiated is such that the normal position is preferably substantially flush with the surface of the photosensitive drum.

The optical sensor 226 can be composed of a light receiving element made of a semiconductor such as polysilicon and amorphous silicon or a compound semiconductor such as germanium and germanium-arsenicum. The light receiving element can be a sensor including a single light receiving element. Furthermore, the light receiving element can be arrayed at intervals of about 5 μm through 1 mm and may constitute channels. In the embodiment shown in FIG. 3, the optical sensor 226 has 16 channels in the light receiving element, but the number of channels to be used is not particularly limited so long as the light receiving element has 8, 16, 32, 128, 256, or higher resolution performance. The output of the light receiving element is input to the CPU 202 and used to calculate an irradiation position. In the embodiment shown in FIG. 3, the optical sensor 226 sequentially sets the channels to be active over the gate period, detects the irradiation of the optical beam Ln or Li within a period in which gate voltage is applied, and sends the detection signal to the CPU 202. The CPU 202 analyzes the channel that generates the detection signal and calculates the irradiation position of the irradiated optical beam.

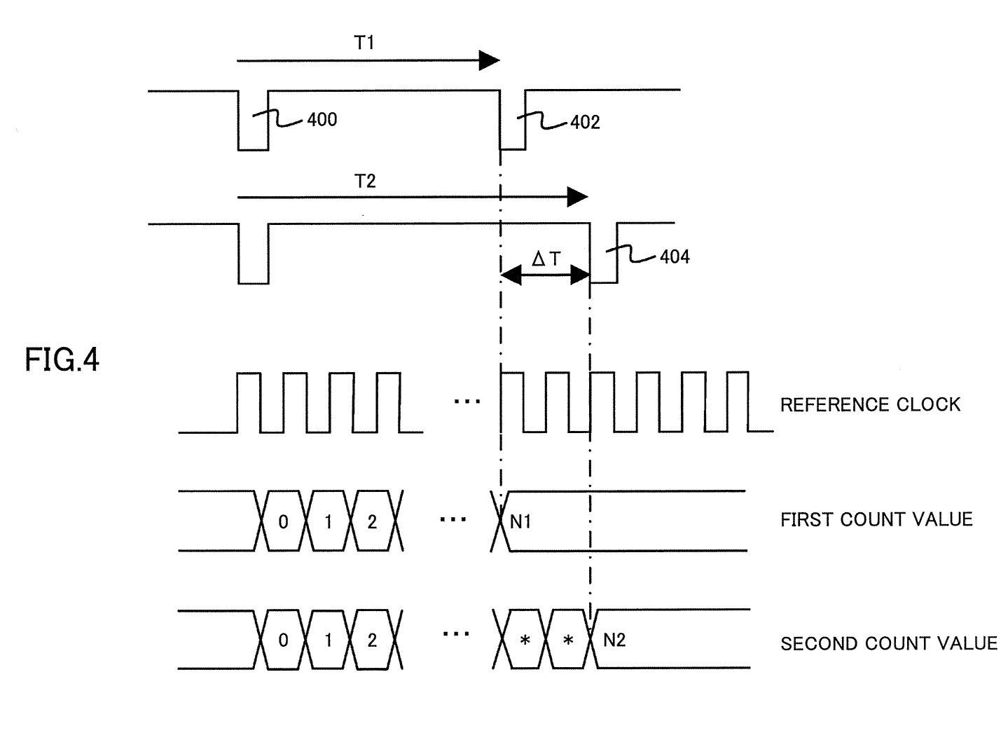

FIG. 4 shows a timing chart for detecting a shift amount in the sub-scanning direction (length dimension) directly using a time signal in the detection device 212 of FIG. 3. Upon detection of an irradiation signal 400, the CPU 202 activates a reference clock to start counting with respect to the CPU 202. The optical beam Ln irradiated at the normal position 1 generates a detection signal 402 at time T1 based on the detection timing of the irradiation signal 400. Subsequently, a similar detection operation is performed for every scanning period in the main scanning direction, so that time T2 is measured. If the value of T2 shows a count difference equivalent to, for example, the threshold ε of a shift amount in the sub-scanning direction, the CPU 202 determines that a positional shift in the sub-scanning direction occurs and thus provides instructions for correcting the same.

In the case of the first embodiment shown in FIG. 4, an amount for correcting the positional shift in the sub-scanning direction can be calculated by the following formula (1) using the values of T1 and T2 based on the irradiation signal 400.

### [Formula 1]

y=CONST×(T2−T1)×tan θ (1)

wherein CONST represents the moving speed (mm/s) of an optical beam in the main scanning direction and is determined by the rotational speed of the polygon mirror 102c. Furthermore, y represents a scanning shift amount (mm) in the direction orthogonal to an optical beam in the sub-scanning direction, T1 and T2 represents a time difference until the detection signal is acquired, and θ represents an angle (rad or deg) of the irradiation position sensor relative to an optical beam.

According to another embodiment of the detection device 212, it is also possible to directly detect a difference between the scanning positions of the optical beams Ln and Li to measure a shift amount in the sub-scanning direction. For example, when the irradiation position sensor 222 has detection channels in its light receiving element, it is possible to calculate a shift amount between the scanning positions of the scanning line at the normal position and that at the position where a positional shift in the sub-scanning direction occurs, using a channel where the detection signal is generated and a channel number difference ΔC between the normal position and the position where the positional shift in the sub-scanning direction occurs. In this case, the CPU 202 stores a look-up table in which sizes per channels and shift amounts are associated with each other, thereby making it possible to calculate the shift amount from the channel where the detection signal is generated.

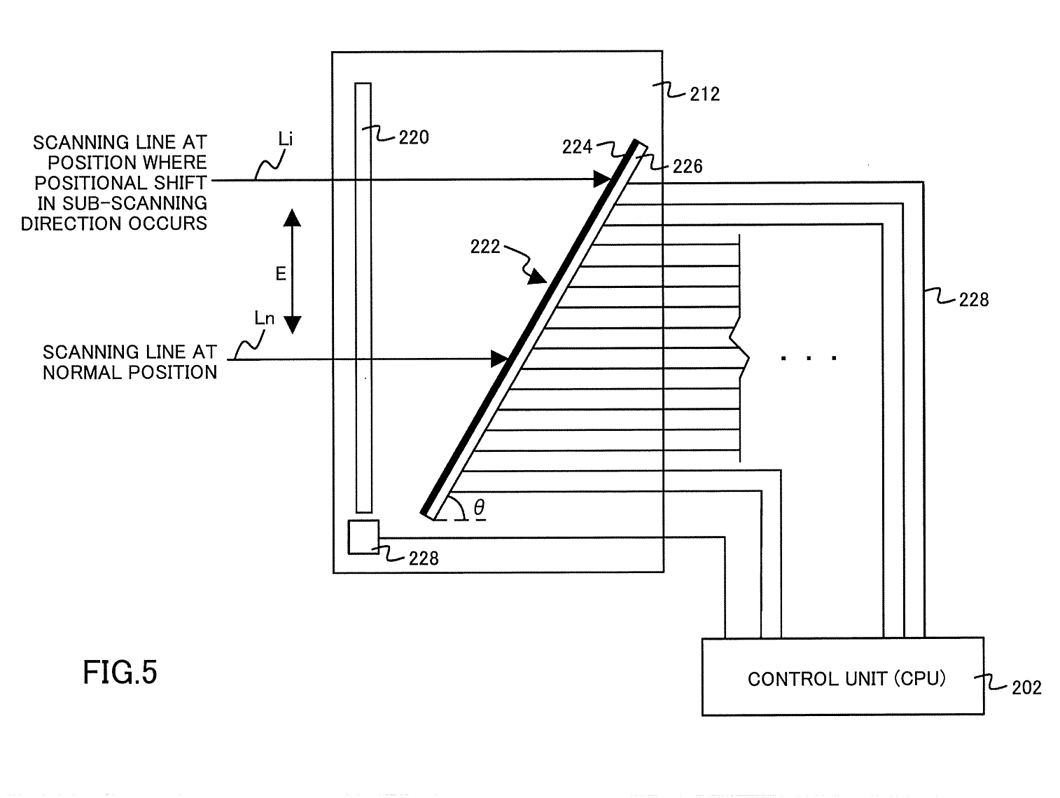

FIG. 5 shows another embodiment of the detection device 212. In the embodiment shown in FIG. 5, it appears that the detection device 212 can be used as a stopper for the optical beam L in both a case viewed from the direction as indicated by arrow D and that viewed from the direction as indicated by arrow D′ in FIG. 2. The detection device 212 shown in FIG. 5 includes the irradiation sensor 220 and the irradiation position sensor 222, and the irradiation sensor 220 is used to detect the irradiation of the optical beam of Ln or Li and generate a measurement gate. Note that the cover plate 224 may be provided just to protect the optical sensor 226 as described above or may be coated with a light emitting material that generates light of long on-interval (about several μs through about several ms) with the irradiation of the optical beam of Li or Ln so as to increase the measurement time interval up to about several ms.

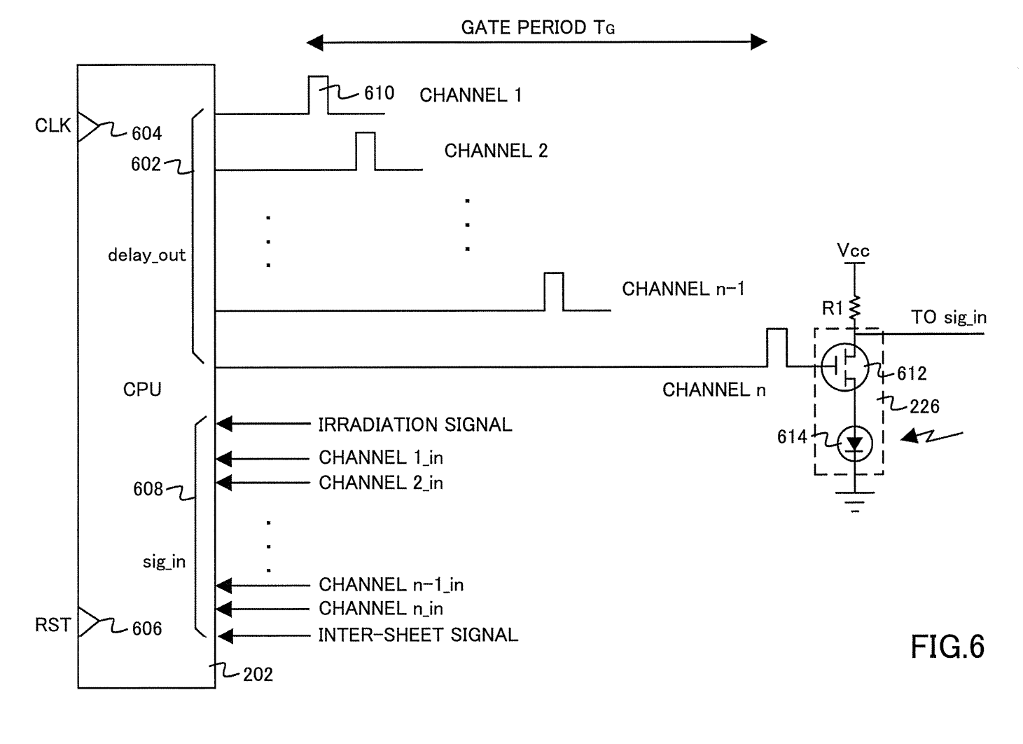

FIG. 6 shows a second embodiment of a detection circuit including the CPU 202 and a control method. The CPU 202 is configured to be an ASIC including a system clock input port 604 and a reset port 606. Furthermore, the CPU 202 is composed of an output port 602 including plural ports and an input port 608 including plural ports that receives the detection signals from respective channels of the light receiving element. A gate signal 610 is generated as a pulse having a predetermined gate width, and in the embodiment shown in FIG. 6, a pulse train of delay time in which plural gate signals are sequentially set is generated over a gate period T_{G}. The gate signal is used as the gate signal of the optical sensor 226. Where the emission of light attributable to an optical beam is detected when a gate potential is asserted (HIGH in the embodiment shown in FIG. 6), the detection signal is generated so that the gate potential is asserted LOW. Note that the time interval of the gate signal and the gate period T_{G} can be set as appropriate within a range capable of performing proper measurement.

In a specific embodiment, the optical sensor 226 can be configured to arrange as channels “1” through “n” channels each composed of a light receiving element 614 and a switching element such as a FET or a MOSTFET 612 having an open drain configuration in which a drain electrode is pulled up with Vcc and a pull-up resistance R1. The detection signal output from a relevant channel of the optical sensor 226 is sent to the input port 608 of the CPU 202 directly or via an appropriate interface and stored in the register memory so as to be processed with the CPU 202.

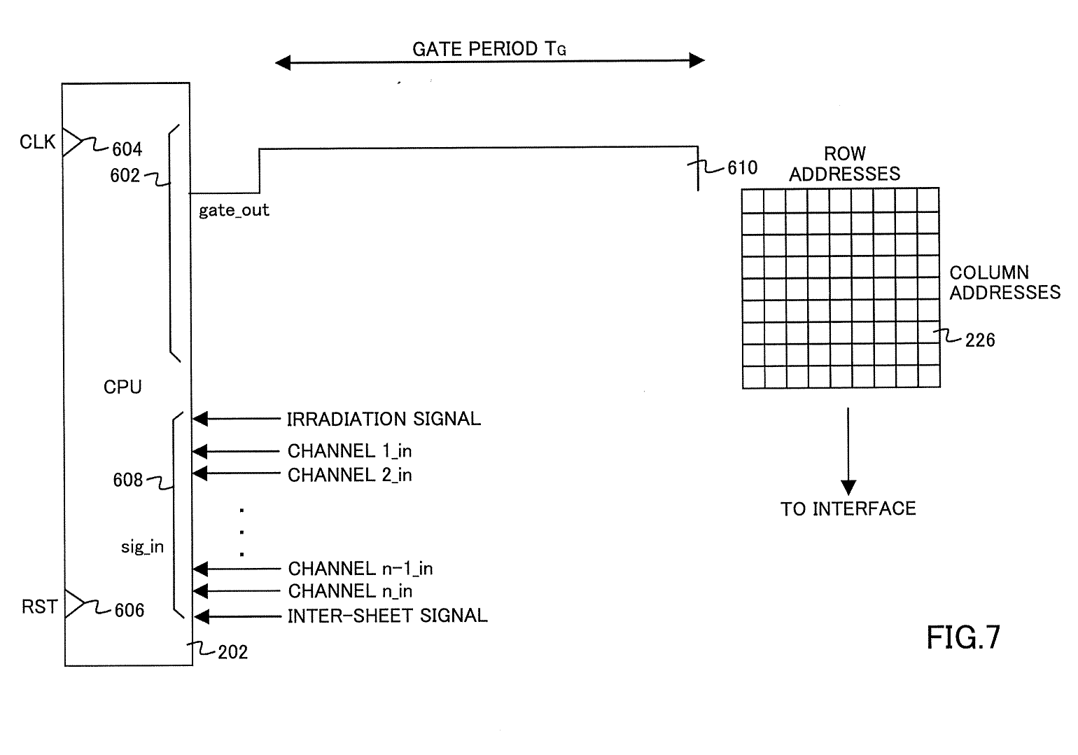

FIG. 7 shows a third embodiment of the detection circuit including the CPU 202 and the control method. In the embodiment shown in FIG. 7, the CPU 202 generates the gate signal 610 from the output port 602 over the gate period T_{G}. On the other hand, the optical sensor 226 is made of a two-dimensional photodiode array, a CCD, or a CMOS sensor comprising a two-dimensional channel. In the optical sensor 226, a row address and a column address are specified for each channel, and the optical sensor 226 sends the output of the addresses to the CPU 202 via an appropriate interface. The CPU 202 acquires the values of the row address and the column address of the channel where the detection signal is asserted. Then, in order to control the position in the sub-scanning direction, the CPU 202 calculates the shift amount of the optical beam Li in the sub-scanning direction by referring to the shift amount data of the look-up table or the like in which are stored the differences between the values of the acquired addresses and the row address and the column address of the channel registered as the normal position as well as the shift amounts according to the differences between the addresses.

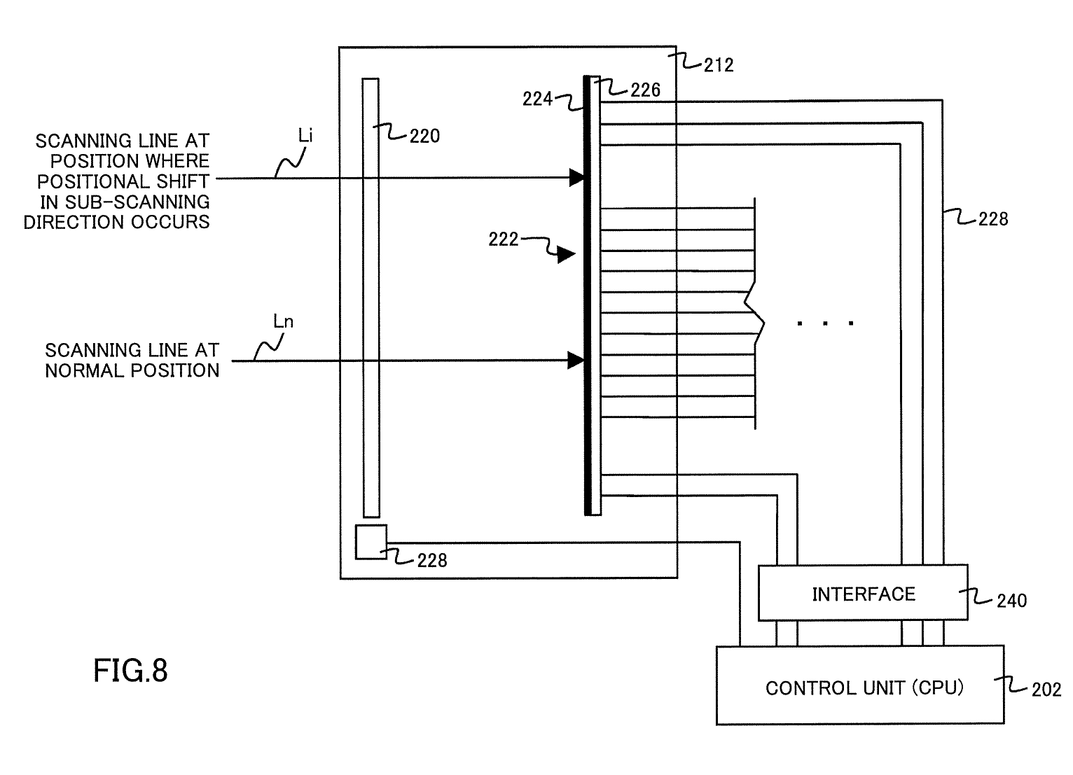

FIG. 8 shows another embodiment of the detection device 212 that can be used with the control method as described in FIG. 7. In the embodiment shown in FIG. 8, the irradiation position sensor 222 is disposed perpendicular to the direction of the scanning lines of the optical beams Ln and Li or to the moving directions thereof. Furthermore, output lines corresponding to the number of channels are derived from the optical sensor 226 and input to the CPU 202 via an appropriate interface 240. The CPU 202 detects the irradiation signal. The CPU 202 uses the irradiation signal as a trigger and asserts the gate signal over the gate period T_{G}. The optical sensor 226 informs the CPU 202 of the address of the channel where an optical beam is detected so that a shift amount in the sub-scanning direction is calculated.

In the embodiment shown in FIG. 8, since it is not necessary to obliquely arrange the irradiation position sensor 222, the detection device 212 can be reduced in size. In addition, since a shift amount in the sub-scanning direction can be constantly detected at the position corresponding to the surface of the photosensitive drum regardless of the irradiation position of the optical beam Li to be irradiated, it is possible to further improve measurement accuracy. Note that in still another embodiment of the detection device 212 the irradiation sensor 220 may be obliquely arranged relative to the optical beams Ln and Li.

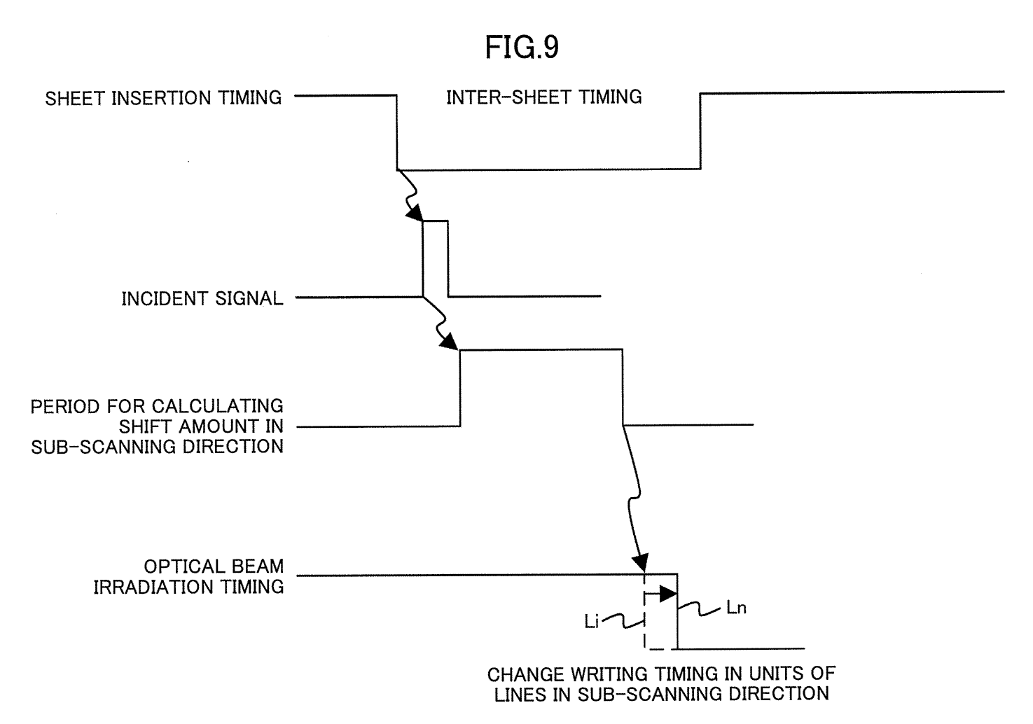

FIG. 9 shows a timing chart of a process for detecting a shift amount in the sub-scanning direction performed by the image forming apparatus 100. The detection of a shift amount in the sub-scanning direction can be performed at any time upon completion of a scanning operation in the main scanning direction. However, if the process for correcting a positional shift in the sub-scanning direction is performed during the execution of jobs and during the image forming process of the image forming apparatus 100, visible irregularities in images are caused to occur. For this reason, the correction process is preferably performed between sheet insertions, i.e., at inter-sheet timing.

In order to detect a shift amount in the sub-scanning direction at the inter-sheet timing, two embodiments can be used. According to a first embodiment, the CPU 202 detects and calculates a shift amount in the sub-scanning direction upon detection of a first irradiation signal after confirming that the shift amount is to be detected at the inter-sheet timing.

Furthermore, according to a second embodiment, a shift amount in the sub-scanning direction is successively detected and calculated during the execution of jobs in advance. If the CPU 202 detects a shift amount larger than or equal to a threshold, the CPU 202 sets a positional shift flag in the sub-scanning direction and the shift amount in the register memory or the like so that the correction process is performed simultaneously with the inter-sheet timing. Below, a description is made of the correction process using the timing chart of the first embodiment shown in FIG. 9.

In the first embodiment shown in FIG. 9, the CPU 202 starts the process for detecting a shift amount in the sub-scanning direction upon detection of the first irradiation signal after the inter-sheet timing of the image forming apparatus 100 is asserted, and generates the gate signal over the gate period T_{G}.

The CPU 202 acquires the detection signal over the gate period T_{G} and determines whether a shift amount in the sub-scanning direction falls within the range of a threshold. If the shift amount is smaller than or equal to the threshold, the CPU 202 does not provide instructions for correcting the shift amount. If the shift amount exceeds the threshold, the CPU 202 informs the function section that corrects a shift amount of the value itself of the shift amount or calculated correction parameters as described below, so as to provide instructions for correcting the shift amount. Note that, in the embodiment where a positional shift in the sub-scanning direction is successively measured, the CPU 202 detects the positional shift flag in the sub-scanning direction set in the register memory upon assertion of the inter-sheet timing. If a value is set in the positional shift flag in the sub-scanning direction, the CPU 202 informs the function section that corrects a shift amount of the fact, so as to start the correction process.

As the correction process for a shift amount in the sub-scanning direction, three embodiments can be used as modes to suit particular applications and purposes, and these embodiments can be used in combination. A first embodiment refers to a correction process in which the drive timing of the LD 206 is corrected, the second embodiment refers to a correction process in which the peripheral speed of the photosensitive drum is changed, and the third embodiment refers to a correction process in which the translational or the rotational movement of the optical elements is made in a mechanical manner. FIG. 9 shows as the embodiment for correction control the first embodiment in which timing control is made in units of lines in the sub-scanning direction.

In the first embodiment of the correction control shown in FIG. 9, if a shift amount in the sub-scanning direction exceeds the threshold ε after the calculation of the shift amount is completed or a period for calculating the shift amount in the sub-scanning direction such as the gate period T_{G} for measuring data for a positional shift is ended, the CPU 202 calculates the number of lines of the photosensitive drum so that the drive timing of an optical beam corresponds to the shift amount. If the shift amount is smaller than or equal to the threshold ε, the CPU 202 starts the subsequent image forming process without performing the correction process. If the shift amount exceeds the threshold ε, the drive timing of the LD 206 is advanced or delayed, e.g., in units of lines depending on the calculated number of lines and the rotational speed of the photosensitive drum as shown in FIG. 9, so as to correct the positional shift in the sub-scanning direction.

In the embodiment shown in FIG. 9, the drive timing is delayed by an amount corresponding to a predetermined line to correct the positional shift in the sub-scanning direction. In the first embodiment, correction of about 0.00423 mm is possible in a shift amount in the sub-scanning direction by controlling the start timing of a line in the case of the resolution of 600 dpi, although it depends on the number of set lines. In the case of the correction control shown in FIG. 9, the shift amount acquired by the CPU 202 can be directly reflected into the control of driving an optical beam, thereby making it possible to correct the positional shift in the sub-scanning direction without using additional devices and drivers.

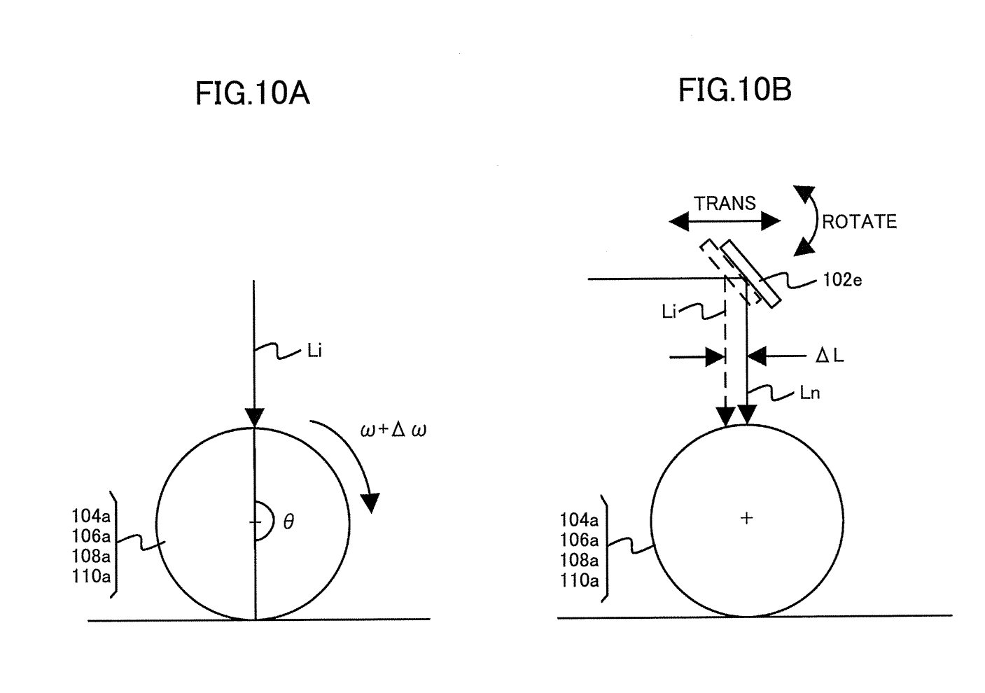

Referring to FIGS. 10A and 10B, a description is now made of the second and third embodiments. The correction processes of the second and third embodiments are shown in FIGS. 10A and 10B, respectively. In FIG. 10A, the correction of a positional shift in the sub-scanning direction caused by an optical beam is performed by correcting the peripheral speed of the photosensitive drum. According to the second embodiment, the correction of the angular speed of a corresponding photosensitive drum is made based on the following formula (2) to correct the irregularities of colors in the images transferred onto the intermediate transfer belt, representing the rotational angle until developing agent images carried on the photosensitive drum reach the intermediate transfer belt as θ (rad), the diameter of the photosensitive body as r (mm), the angular speed of the photosensitive drum as ω (rad/s) and the fine adjustment amount of the angular speed as Δω (rad/s).

### [Formula 2]

y=rθ×Δω/ω

Δω=y×Δω/(rθ) (2)

wherein y represents a shift amount (mm) in the sub-scanning direction.

In the second embodiment, the shift amount in the sub-scanning direction acquired by the CPU 202 is supplied to a unit that controls the driving of the photosensitive drum, and the unit controls the peripheral speed of the photosensitive drum to perform the correction process. Thus, it is possible to perform the correction process just by correcting the processing program of the unit.

According to the third embodiment, the CPU 202 calculates a translational movement amount or a rotational angle canceling the shift amount y in the sub-scanning direction to correct the shift amount and instructs the unit that controls the driving of the optical elements to drive a stepping motor or the like. In the embodiment shown in FIG. 10B, the reflection mirror 102e is translated from the position as indicated by broken lines where a positional shift in the sub-scanning direction occurs to the position as indicated by solid lines. The position as indicated by solid lines is the position where the photosensitive drum is irradiated with an optical beam at the set position. The translational movement amount ΔL (mm) is provided by the following formula (3).

ΔL=r×sin(y/r) [Formula 3]

In the third embodiment, it is necessary to separately install the unit that drives the optical elements. However, it is possible to correct a larger shift amount compared with the correction in units of lines in the sub-scanning direction and the control of the peripheral speed of the photosensitive drum.

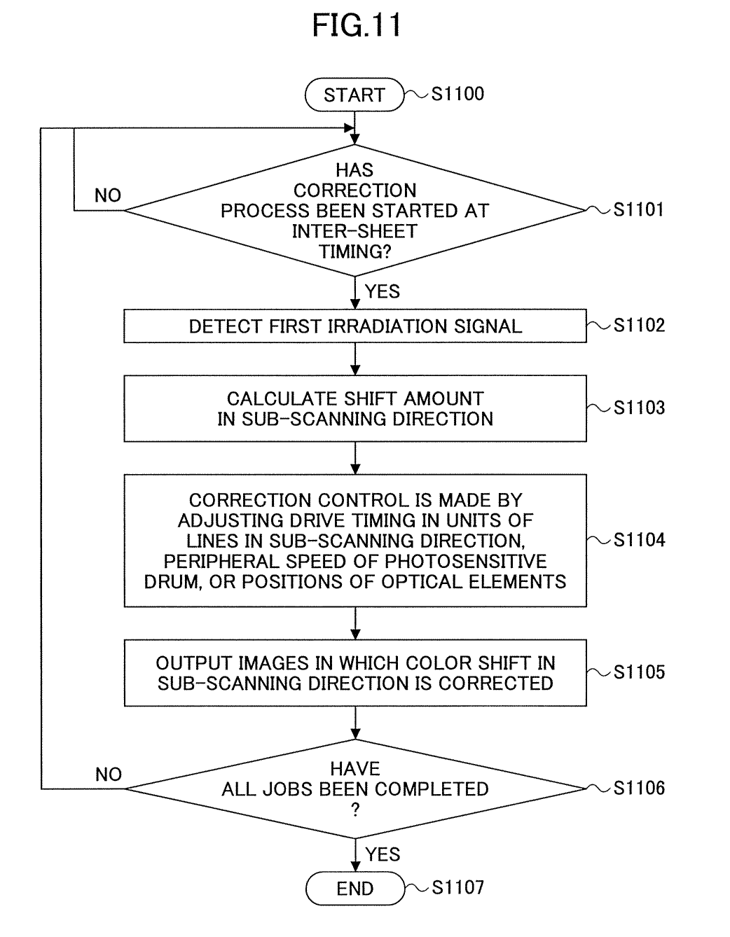

FIG. 11 shows a flowchart of the first embodiment of the image forming method performed by the image forming apparatus 100. The process shown in FIG. 11 starts at step S1100 and then proceeds to step S1101 where it is determined whether the correction process has been started at the inter-sheet timing. In step S1102, the first irradiation signal is detected. Then, the process proceeds to step S1103 where the process for calculating a shift amount in the sub-scanning direction is started by measuring timing T1 and T2 or asserting the gate signal.

In step S1104, the correction is made by controlling the drive timing of an optical beam in units of lines in the sub-scanning direction, the peripheral speed of the photosensitive drum, or the positions of the optical elements. In step S1105, images in which the shift amount in the sub-scanning direction is corrected are output, and then the process proceeds to step S1106 where it is determined whether any data used to form other images exist. If there exist the data used to form other images and thus jobs are not to be completed (no), the process returns to step S1101 to determine the timing of the subsequent correction. If it is determined that all the jobs have been completed (yes), the process is branched into step S1107 to end the correction process.

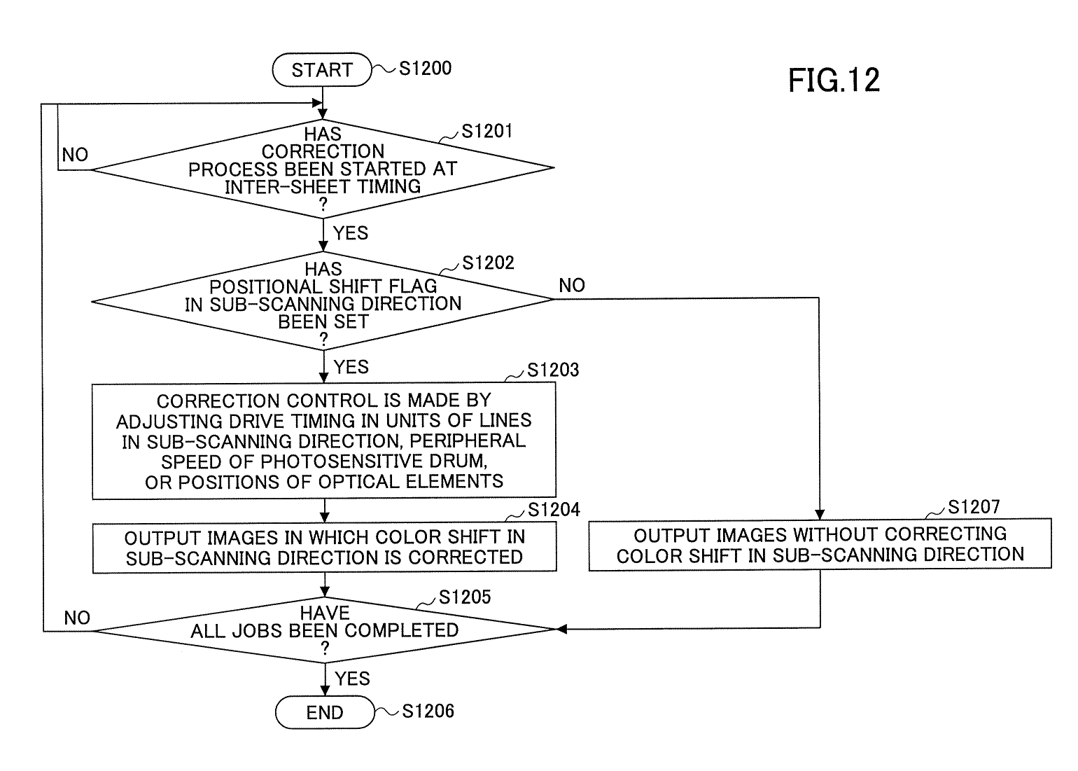

FIG. 12 shows a flowchart of the second embodiment of the image forming method performed by the image forming apparatus 100. The process starts at step S1200 and then proceeds to step S1201 where it is determined whether the correction process has been started at the inter-sheet timing. In step S1202, it is determined whether the positional shift flag in the sub-scanning direction, which is set using a shift amount in the sub-scanning direction detected and calculated during image formation, has been set. If it is determined that the positional shift flag has not been set in step S1202 (no), the process is branched into step S1207 because there is no need to perform the correction. After the image formation is performed without correcting a positional shift in the sub-scanning direction, the process is branched into step S1205.

In step S1202, if it is determined that the positional shift flag in the sub-scanning direction has been set (yes), the process proceeds to step S1203 where the calculated shift amount in the sub-scanning direction stored in the register memory is read out to make the correction control by controlling the drive timing of an optical beam in units of lines in the sub-scanning direction, the peripheral speed of the photosensitive drum, or the positions of the optical elements. In step S1204, images in which the shift amount in the sub-scanning direction is corrected are output, and then the process proceeds to step S1205 where the image forming apparatus 100 determines the completion of jobs by confirming whether any data used to form other images exist. If all the jobs have not been completed (no), the process returns to step S1201 to determine the timing of the subsequent correction. If it is determined that all the jobs have been completed (yes), the process is branched into step S1206 to end the image forming process of the image forming apparatus 100.

According to the embodiments of the present invention, it is not necessary to stop operating jobs of the image forming apparatus and separately perform a correction process for drawing a color shift detection pattern, thereby reducing frequent maintenance by a specialized service person. In addition, it is possible to shorten correction time, reduce wasteful toner consumption, and perform a remote color shift correction. Moreover, since the correction time can be shortened, the frequency of corrections can be increased. Accordingly, the color matching accuracy, color reproducibility, and picture stability can be improved with time.

The present invention is not limited to the specifically disclosed embodiments, and variations and modifications may be made without departing from the scope of the present invention.

The present application is based on Japanese Priority Application No. 2007-069833 filed on Mar. 19, 2007, the entire contents of which are hereby incorporated herein by reference.

What is claimed is:

1. An image forming apparatus comprising:
an optical device including an optical source that is driven corresponding to image data, a deflection unit that deflects an optical beam output from the optical source in a main scanning direction, and an optical element that reflects the optical beam onto a photosensitive drum;
a detection device that is arranged outside the optical device and detects a positional shift of the optical beam in a sub-scanning direction defined as a direction orthogonal to the main scanning direction; and
a control unit that corrects the positional shift in the sub-scanning direction using an output from the detection device.

2. The image forming apparatus according to claim 1, wherein
the detection device includes an irradiation sensor and an irradiation position sensor, and the irradiation position sensor is disposed in such a way as to be flush with the photosensitive drum of the image forming apparatus relative to the optical beam.

3. The image forming apparatus according to claim 1, wherein
the control unit corrects the positional shift in the sub-scanning direction by controlling drive timing of the optical beam in units of lines in the sub-scanning direction, transfer timing of a developing agent image of the photosensitive drum onto an intermediate transfer belt, or a spatial position of the optical element.

4. The image forming apparatus according to claim 1, wherein
the control unit detects inter-sheet timing of the image forming apparatus to correct the positional shift.

5. The image forming apparatus according to claim 2, wherein
the irradiation position sensor is obliquely arranged relative to the irradiation sensor.

6. An image forming method of an image forming apparatus having an optical device including an optical source that is driven corresponding to image data, a deflection unit that deflects an optical beam output from the optical source in a main scanning direction, and an optical element that reflects the optical beam onto a photosensitive drum, the method comprising:
a detection step of detecting the optical beam in a sub-scanning direction defined as a direction orthogonal to the main scanning direction outside the optical device and at a surface level of the photosensitive drum of the image forming apparatus;
a calculation step of calculating a shift amount in the sub-scanning direction based on a positional shift of the detected optical beam;
a control step of controlling the calculated shift amount to be corrected; and
an output step of outputting an image in which the positional shift in the sub-scanning direction is corrected.

7. The image forming method according to claim 6, wherein
the calculation step includes a step of calculating a difference between the optical beam having a different scanning period and a set position in the sub-scanning direction.

8. The image forming method according to claim 6, wherein
the control step includes a step of calculating, using the shift amount between the optical beam and a set position, a difference in timing of the optical beam in units of lines in the sub-scanning direction, a difference in a peripheral speed of the photosensitive drum, a difference in a translational position of the optical element, or a difference in a rotational angle of the optical element.

9. The image forming method according to claim 6, wherein
the control step further includes:
a step of detecting inter-sheet timing of the image forming apparatus; and
a step of calculating the shift amount within the inter-sheet timing, starting a correction of the shift amount if the shift amount exceeds a threshold, and completing the correction within the inter-sheet timing.

10. The image forming method according to claim 6, wherein
the control step further includes:
a step of detecting inter-sheet timing of the image forming apparatus;
a step of determining whether the shift amount exceeds a threshold after starting a correction of the shift amount at the inter-sheet timing; and
a step of starting the correction if it is determined that the shift amount exceeds the threshold and completing the correction within the inter-sheet timing.
